(19) United States
(12) Patent Application Publication
(10) Pub. No.: US 2026/0309304 A1
(43) Pub. Date: Oct. 8, 2026

(54) LIGHTING DEVICE

(71) Applicant: SIGNIFY HOLDING B.V., EINDHOVEN (NL)

(72) Inventors: RENÉ BELTMAN, VUGHT (NL); MICHEL CORNELIS JOSEPHUS MARIE VISSENBERG, ROERMOND (NL); BARTEL MARINUS VAN DE SLUIS, EINDHOVEN (NL)

(21) Appl. No.: 19/481,412

(22) PCT Filed: Apr. 18, 2024
(86) PCT No.: PCT/EP2024/060535

§ 371 Date: Nov. 4, 2025

(30) Foreign Application Priority Data
May 4, 2023 (EP) 23171493.2
May 4, 2023 (EP) 23171502.0

(51) Int. Cl. F21V 5/00; F21S 8/08; F21V 5/04; F21V 5/08; F21V 7/04; F21Y 105/16; F21Y 115/10

(52) U.S. Cl. CPC F21V 5/007; F21V 5/048; F21V 5/08; F21V 7/043; F21S 8/085; F21Y 2105/16; F21Y 2115/10

(57) ABSTRACT

According to an aspect, there is provided a lighting device comprising: a cluster of lighting units (104), each lighting unit (106,108) comprising a respective LED-based light source (1061,1081) and a respective lens (1062,1082) arranged in front of the respective light source and adapted to output a respective individual light beam, wherein the cluster of lighting units is configured to output a collective light beam formed by a sum of the individual light beams, wherein the cluster of lighting units comprises a first peripheral lighting (106) unit and a second peripheral lighting (108) unit arranged at opposite peripheral sides of the cluster (104), and wherein the respective lens (1062,1082) of the first and second peripheral lighting units is adapted to shape light collected from the respective light source such that a mean intensity direction of the respective individual light beam is directed away from a center axis of the cluster.

### FIELD OF THE INVENTION

The present invention generally relates to a lighting device.

### BACKGROUND OF THE INVENTION

In luminaires, the light is often generated by a plurality of light emitting diodes (LEDs) to produce an output beam with the desired amount of flux and/or to allow the LEDs to be driven at an appropriate voltage. LEDs are typically Lambertian sources. Hence, to produce a light beam suitable for a specific application, beam forming optics such as lenses, sometimes in combination with reflectors, are often used.

One approach is to use a single lens collecting the light of all the LEDs to produce the desired beam. Another approach is to use a smaller individual lens for each individual LED. Using an individual optic per LED enables improved control over the light beam as well as smaller luminaires. The desire to have many LEDs in a relatively small area however poses a difficulty for the use of a single optic per LED, because the separation between the LEDs becomes limited. A greater area density of LEDs with individual lenses thus increases the risk of lens cross talk since the lens for one LED may extend into and hence intercept the light path of its neighboring LEDs, wherein the lens may refract some the intercepted light in unintended directions.

### SUMMARY OF THE INVENTION

It is an object of the present invention to provide an improved design of a lighting device which enables a plurality of LED-based light sources with individual lenses to be combined with a smaller spacing than allowed by conventional designs, while mitigating a risk for lens cross talk. These and other objects may be achieved by a lighting device in accordance with the independent claim. Embodiments of the present invention are defined in the dependent claims.

Hence, according to an aspect of the present invention, there is provided a lighting device comprising:
a cluster of lighting units, each lighting unit comprising a respective LED-based light source and a respective lens arranged in front of the respective light source and adapted to output a respective individual light beam,
wherein the cluster of lighting units is configured to output a collective light beam formed by a sum of the individual light beams,
wherein the cluster of lighting units comprises a first peripheral lighting unit and a second peripheral lighting unit arranged at opposite peripheral sides of the cluster, and
wherein the respective lens of the first and second peripheral lighting units is adapted to shape light collected from the respective light source such that a mean intensity direction of the respective individual light beam is directed away from a center axis of the cluster.

Thus, the present invention is based on the idea of combining two or more lighting units (each comprising a LED-based light source and a lens) in a cluster wherein the lenses of the peripheral lighting units of the cluster are designed to produce individual light beams having mean intensity directions pointing away from, i.e. being divergent with, the center axis of the cluster. Accordingly, the respective mean intensity directions of the individual light beams output by the peripheral lighting units may diverge from the mean intensity direction of the collective light beam. As more intensity/power of the individual light beams is refracted towards an outside of the cluster, the lenses may be shaped such that the lenses may be arranged closer to the center axis with a reduced risk of lens cross talk. For instance, the lenses may be shaped such that a thickness or extension of the lens portions closer to the center axis (i.e. inner lens portions) is reduced relative the lens portions farther from the center axis of the cluster (i.e. outer lens portions). The lenses of the peripheral lighting units (which in the following for brevity may be referred to as “peripheral lenses”) may hence be arranged closer to a neighboring lens and lighting unit.

By the term “LED-based light source” is here meant a light source comprising one or more LEDs. For instance, a LED-based light source may be or consist of a single LED. However, a LED-based light source may also be or consist of an array of two or more LEDs. In either case, the light output by the LED-based light source (be it a single LED or an array of LEDs) is shaped by a single common lens arranged in front of the LED-based light source.

By the term “peripheral lighting unit” is here meant a lighting unit arranged along a periphery of the cluster. Thus, a peripheral lighting unit constitutes an outermost lighting unit of the cluster, as seen in a plane of extension of the cluster.

According to an embodiment, the respective lens of the first and second peripheral lighting units is an asymmetric lens that comprises a first lens portion and a second lens portion, wherein the first lens portion is closer to the center axis of the cluster than the second lens portion, and wherein the first lens portion has a smaller thickness than the second lens portion. This allows the peripheral lenses to be positioned closer to the center axis of the cluster, and thus closer to a neighboring lens (be it a peripheral or non-peripheral lens) with less risk of intercepting the light path of the neighboring lighting unit.

According to an embodiment, the first and second portions of the respective lenses are adapted to refract a majority of the intensity of the light collected from the respective light source in a direction away from the center axis of the cluster.

According to an embodiment, the respective lens of each of the first and second peripheral lighting units has a single symmetry plane intersecting the respective lens of another peripheral lighting unit arranged along an opposite side of the cluster. Two such opposite peripheral lighting units may thereby be arranged closer to each other, as seen along a plane of extension of the respective symmetry planes, towards the opposite peripheral lighting unit.

By “single symmetry plane” is hereby meant that the peripheral lenses each have exactly (i.e. only) one symmetry plane, and hence present mirror symmetry (or lateral symmetry). In contrast, traditional lighting devices based on LED-based light sources with individual beam-forming optics typically employ lenses with radial symmetry (e.g. spherical lenses) or quadrant symmetry (e.g. “peanut” lenses). According to the present embodiment, the lenses of the peripheral lighting units however have fewer symmetry planes than the lenses of such traditional lighting devices.

The other peripheral lighting unit arranged along the opposite side of the cluster with respect to the first and second peripheral lighting units, may in some embodiments refer respectively to a third and a fourth peripheral lighting unit (e.g. in case of a cluster comprising at least four peripheral lighting units). However, the other peripheral lighting unit may also refer to the second and first peripheral lighting units. That is, in some embodiments the symmetry plane of the lens of the first peripheral lighting unit may intersect the lens of the second peripheral lighting unit, and vice versa.

According to an embodiment, the cluster of lighting units is configured such that, for a uniform flux of the respective LED-based light sources, the collective light beam is symmetric with respect to a symmetry plane coinciding with the center axis, wherein the symmetry is at least one of mirror symmetry, quadrant symmetry or radial symmetry. This configuration enables a lighting device which may produce a symmetric collective light beam.

While the LED-based light sources (in particular the light sources of the peripheral lighting units) may be configured to, in use of the lighting device, output a substantially uniform flux, it is noted that the preceding embodiment does not preclude that one or more of the LED-based light sources, in use, are configured to output a different flux than the other LED-based light sources of the cluster. For instance, an output flux of at least one of the LED-based light sources (e.g. of at least one of the peripheral lighting units) may be adjustable independently from the other LED-based light sources.

According to one embodiment, the cluster of lighting units comprises a third and fourth peripheral lighting unit, wherein the first, second third and fourth lighting units are arranged in a regular grid and located at respective corners of the cluster, and wherein the respective lens of the third and fourth peripheral lighting units is adapted to shape light collected from the respective light source such that a mean intensity direction of the respective individual light beam is directed away from the center axis of the cluster. This enables a lighting device wherein the lenses and lighting units may be arranged closer to the center axis of the cluster with a reduced risk of lens cross talk. According to this arrangement, the respective mean intensity directions of the individual light beams output by the first through fourth peripheral lighting units may be divergent, both from each other and from the center axis of the cluster.

According to one embodiment, the first, second, third and fourth peripheral lighting units are neighboring lighting units of the cluster. The cluster may hence be formed as a four-lighting unit cluster. This configuration lends itself favorably to a lighting device intended to produce a collective light beam being radially or quadrant symmetric. The collective light beam may in particular be emitted along the center axis, which thus may define the optical axis of the lighting device.

According to an alternative embodiment, the cluster of lighting units comprises a first set of peripheral lighting units and a second set of peripheral lighting units arranged along the opposite peripheral sides of the cluster, and wherein each peripheral lighting unit of the first and second set comprises a respective lens, wherein each lens is adapted to shape light collected from the respective light source such that a mean intensity direction of the respective individual light beam is directed away from the center axis of the cluster. This configuration may be suitable for producing a collective light beam with mirror symmetry.

The lenses of the first and second sets of peripheral lighting units may be adapted to shape the collected light such that the mean intensity direction of the respective individual light beam is directed away from the opposite peripheral side of the cluster.

The cluster of lighting units may further comprise a sub-cluster of lighting units, each comprising an LED-based light source arranged in front of a symmetric lens, wherein a spacing between the lens of a peripheral lighting unit and a neighboring symmetric lens of the sub-cluster is less than a spacing between neighboring symmetric lenses of the sub-cluster. The symmetric lens here refers to a lens shaping a light distribution collected from the LED-based light source of the respective lighting unit into an individual light beam with mirror symmetry (i.e. having only a single plane of symmetry). The symmetric lens may in particular be a so-called “peanut lens”. The sub-cluster may thus be suitable for outputting a spherically or quadrant symmetric portion of the collective light beam, which may be augmented with the light beams output by the first and second sets or peripheral lighting units, directed away from mean intensity direction of the spherically or quadrant symmetric portion of the collective light beam output by the sub-cluster. As may be understood in view of the preceding discussion, the first and second sets of peripheral lighting units, and the peripheral lenses thereof, may be spaced more closely to the neighboring lighting units and lenses of the sub-cluster, with less risk of lens cross talk.

According to one embodiment, the first and second lighting units are neighboring lighting units of the cluster and arranged on opposite sides (i.e. directly opposite sides) of the central axis. This configuration may be suitable for producing a collective light beam with mirror symmetry using only two lighting units.

According to an embodiment, the lighting device further comprises a cup-shaped reflector surrounding the cluster. The reflector enables further shaping of the collective light beam output by the cluster.

### BRIEF DESCRIPTION OF THE DRAWINGS

This and other aspects of the present invention will now be described in more detail, with reference to the appended drawings showing embodiments of the present invention.

FIG. 1 shows as a comparative example a lighting device comprising a cluster of lighting units, each having a symmetric lens.

FIG. 2a-b show, respectively, a view of a lighting device according to an embodiment comprising a cluster of four lighting units, and a view showing one of the four lighting units in isolation.

FIG. 3a-b show plots of an example intensity distribution produced by one of the four lighting units in FIG. 2a.

FIG. 4a-b show plots of an example intensity distributions of a collective light beam produced by the lighting device in FIG. 2a.

FIG. 5a-b shows an example of a so-called “peanut lens” with mirror symmetry and an intensity distribution of a light beam produced by a lighting unit comprising the lens. FIG. 6a-b shows an “asymmetric” peanut lens according to an embodiment and an intensity distribution of a light beam produced by a lighting unit comprising the lens.

FIG. 7 shows a lighting device comprising a cluster of two lighting units comprising lenses according to FIG. 6a, according to an embodiment.

FIG. 8 shows as a comparative example a lighting device comprising a cluster of lighting units with symmetric lenses as shown in FIG. 5a.

FIG. 9 shows a lighting device comprising a cluster comprising a combination of peripheral lighting units with asymmetric peanut lenses and lighting units with symmetric peanut lenses, according to an embodiment.

### DETAILED DESCRIPTION

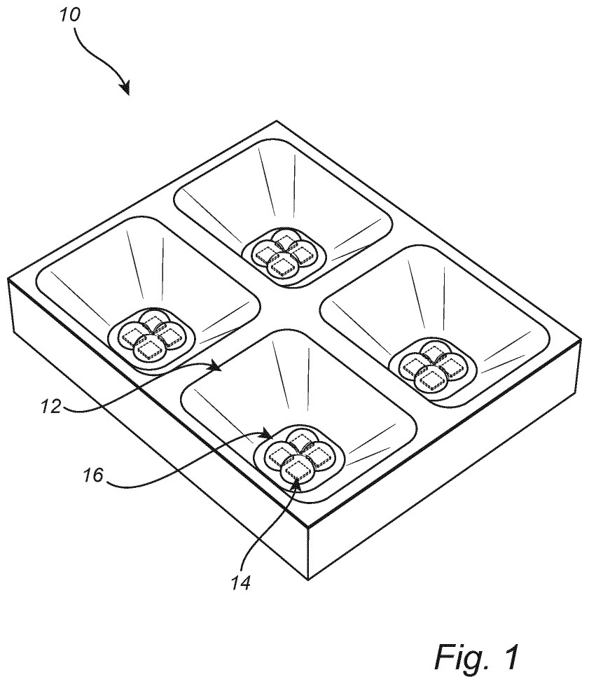

FIG. 1 schematically shows a perspective view of a lighting device 10 with a conventional design comprising a cluster 12 of four lighting units, each comprising a respective LED 14 and a respective lens 16 arranged in front of the respective LED. The cluster 12 is arranged in a reflector cup. As shown in FIG. 1, the lighting device 10 may comprise a plurality of such clusters and reflector cups. As the dimensions of the cluster 12 and the cup are reduced, the spacing between the individual lighting units of the cluster 12 will become smaller, and eventually the individual lenses 16 will become partially overlapping. This tends to reduce the efficiency of the design may also result in creation of hot spots on the cup walls because the partial overlap of the lenses may result in the overlapping lens portions collecting and refracting peripheral rays of the LEDs towards the cup walls instead of out of the cup. In the illustrated example, the lenses 16 are symmetric lenses, more specifically radially symmetric, and hence (assuming LEDs with a Lambertian emission pattern) output individual light beams with a radial symmetry. However, also for lenses with quadrant symmetry (i.e. two transverse symmetry planes) the issue of lens overlap may apply between lenses arranged along a same symmetry plane.

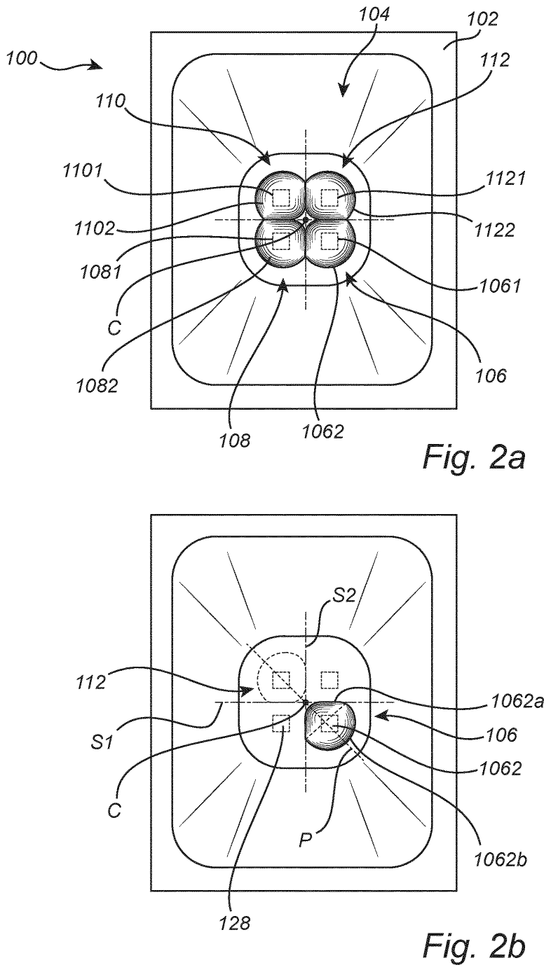

FIG. 2a shows a front view of a lighting device 100 according to an embodiment. The lighting device 100 comprises a cluster 104 of four lighting units, more specifically a first, second, third and fourth lighting unit 106, 108, 110, 112. FIG. 2b depicts the same lighting device 100, but only shows a single one of the lighting units 106, for illustrational clarity.

Reference signs S1 and S2 indicate a pair of transverse symmetry planes of the cluster 104, intersecting at the center axis C of the cluster 104. The lighting units 106, 108, 110, 112 are neighboring lighting units of the cluster 104 and are arranged in a regular grid, wherein each lighting unit 106, 108, 110, 112 is located at a respective corner of the cluster 104. Each of the lighting units 106, 108, 110, 112 are located along the periphery of the cluster 104 and may hence be referred to as peripheral lighting units 106, 108, 110, 112. More specifically, the first and second peripheral lighting units 106, 108 are arranged at mutually opposite peripheral sides of the cluster 104, and the third and fourth peripheral lighting units 110, 112 are arranged at mutually opposite peripheral sides of the cluster 104. A corresponding relationship applies to, on the one hand, the first and fourth lighting units 106, 112, and on the other hand, the second and third lighting units 108, 110.

Each (peripheral) lighting unit 106, 108, 110, 112 comprises, as shown, a respective LED-based light source 1061, 1081, 1101, 1121 and a respective lens 1062, 1082, 1102, 1122 arranged in front of the respective light source 1061, 1081, 1101, 1121. Each of the lenses 1062, 1082, 1102, 1122 is configured to collect and shape the light distribution emitted by the respective light source 1061, 1081, 1101, 1121 into a respective individual light beam. Each lighting unit 106, 108, 110, 112 is thus adapted to output a respective individual light beam.

The LED-based light sources 1061, 1081, 1101, 1121 may be or consist of a single LED, such that each lighting unit 106, 108, 110, 112 comprises exactly (i.e. only) a single respective LED and the single respective lens 1062, 1082, 1102, 1122 arranged in front of the single respective LED. However, the LED-based light sources 1061, 1081, 1101, 1121 may also be formed as respective arrays of two or more LEDs, such that each lighting unit 106, 108, 110, 112 comprises a respective LED array and a single respective lens 1062, 1082, 1102, 1122 arranged in front of the respective LED array. The LED-based light sources 1061, 1081, 1101, 1121 may in either case typically be Lambertian sources (i.e. producing a substantially Lambertian emission pattern). However, the design principles set out herein are not limited to any specific emission pattern but may be applied also to non-Lambertian LED-based light sources.

As shown in FIG. 2a, the lighting device 100 may optionally further comprise a cup-shaped reflector 102 surrounding the cluster 104, in order to further shape the light beams output by the cluster 104. The illustrated shape of the reflector 102 is merely an example and may in general be chosen based on the desired shape of the light distribution to be output by the cluster 104.

In contrast to the spherically symmetric lenses 16 of the cluster 12 in FIG. 1, the lenses 1062, 1082, 1102, 1122 of the lighting units 106, 108, 110, 112 are adapted to shape the light collected from the respective light sources 1061, 1081, 1101, 1121 such that the mean intensity directions of the respective individual light beams diverge from each other and are directed away from the center axis C of the cluster 104.

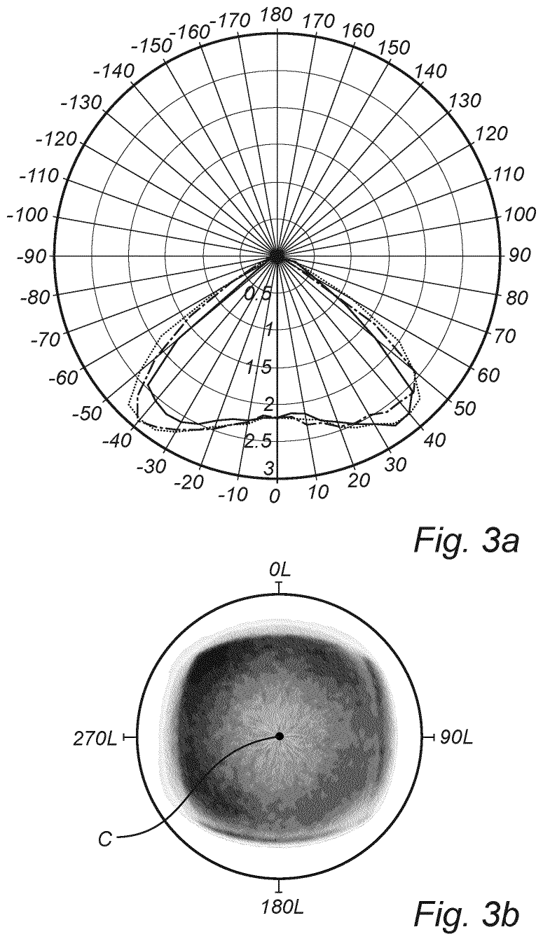

FIG. 3a-b shows an example of the intensity distribution (in far field) of an individual light beam output by one of the lighting units 106, 108, 110, 112. FIG. 3a is a polar plot of the intensity along the 0° (full line), 45° (dotted line) and 90° (dash-dotted) planes. FIG. 3b shows the intensity distribution (darker shade indicating increasing intensity) in a plane transverse to the center axis C. The origin is in both FIG. 3a-b located on the center axis C of the cluster 104. The shifting of both the peak and mean intensity direction away from the center axis C may be readily seen.

The example intensity distribution shown in FIG. 3a-b is representative for each of the lighting units 106, 108, 110, 112. However, as may be understood from the relative orientations of the lenses 1062, 1082, 1102, 1122 in FIG. 2a, the intensity distributions of the individual light beams of the lighting units 106, 108, 110, 112 are mirrored with respect to each other, i.e. about the symmetry planes S1 and S2 of the cluster 104. To illustrate, consider as an example that the coordinate system of FIG. 3b is defined to correspond to the orientation of the lighting device 100 as shown in FIG. 2a (and 2b). That is, the 0L, 90L, 180L and 270L directions in FIG. 3b correspond respectively to the top, right, down and left directions in FIG. 2a. Under this assumption, FIG. 3b represents the intensity distribution of the third lighting unit 110. That is, the mean and peak intensity directions of the third light unit 110 is directed away from the center axis C and towards the corner of the cluster 104 in which the third light unit 110 is arranged. The intensity distributions of the first, second and fourth lighting units 106, 108 and 112 would hence correspond to the intensity distribution of the third lighting unit 110, but with the peak and mean intensity directions instead shifted towards their respective corners of the cluster 104.

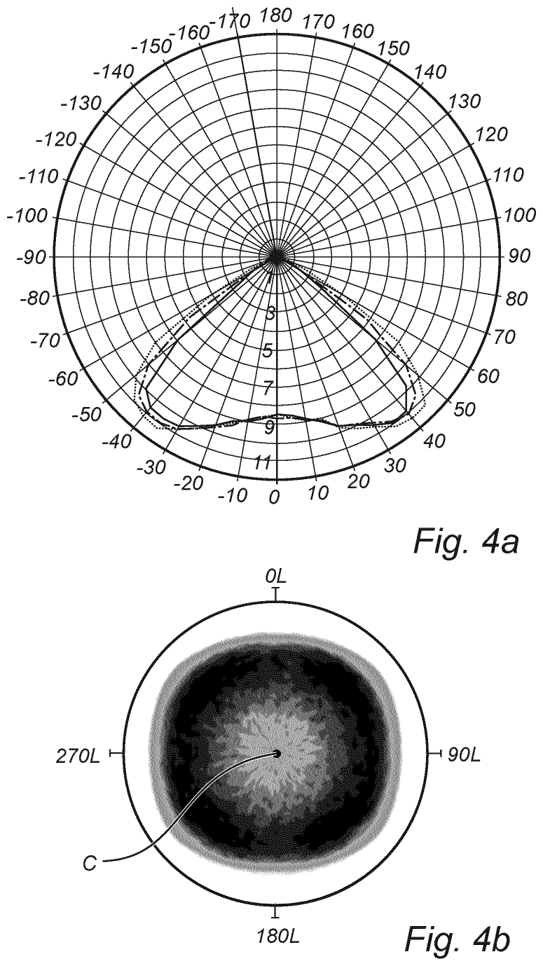

FIG. 4a-b show the beam profile and the corresponding intensity distribution of the resulting collective light beam, formed by the sum of the four individual light beams output by the first, second, third and fourth lighting units 106, 108, 110, 112, assuming a uniform flux output by the respective LED-based light sources 1061, 1081, 1101, 1121. The resulting collective light beam is thus radially symmetric about the center axis C, which thus coincides with the mean intensity direction of the collective light beam. The center axis C in this case hence also constitutes the optical axis of the cluster 104. The cluster 104 may hence output a collective light beam formed by the sum of the four individual light beams output by the lighting units 106, 108, 110, 112, each having a mean (and peak) intensity direction diverging from the mean intensity direction of the collective light beam.

It is to be noted that the specific beam profile and intensity distributions shown in FIG. 3a-b and 4a-b, merely represent an example, and that many other profiles and distributions are possible as long as they correspond to a light beam with a mean intensity direction directed away from the center axis C. For instance, the lenses 1062, 1082, 1102, 1122 may be adapted to shape the light distributions output by the respective LED-based light sources 1061, 1081, 1101, 1121 such that a collective beam, without radial symmetry but presenting quadrant symmetry, is formed.

The outward shifting of the mean intensity distributions of the individual light beams is enabled by the shape of the lenses 1062, 1082, 1102, 1122. The shape will now be discussed in further detail with reference to the first lighting unit 106 and FIG. 2b, but the discussion applies correspondingly to the lenses 1082, 1102, 1122 of the further lighting units 108, 110, 112.

As further shown in FIG. 2b, the lens 1062 comprises a first lens portion 1062a and a second lens portion 1062b. The first lens portion 1062a is located closer to the center axis C of the cluster 104 than the second lens portion 1062b. The first and second lens portions 1062a, 1062b may thus be referred to as inner and outer lens portions, respectively. For instance, the first lens portion 1062a may as shown refer to a portion of the lens 1062 extending from the light source 1061 in an inward direction towards the center axis C, while the second lens portion 1062b may refer to a portion of the lens 1062 extending from the light source 1061 in an outward direction away from the center axis C.

In order to shift the mean (and peak) intensity direction of the individual light beam away from the center axis C, the lens 1062 needs to be more strongly refracting in this direction than towards the center axis C. The first lens portion 1062a may hence as shown present a smaller thickness than the second lens portion 1062b. The smaller extension of the first lens portion 1062a hence reduces a risk of intercepting and refracting light output by the light sources of the neighboring lighting units 108, 110, 112. As the lenses 1062, 1082, 1102, 1122 of each of the lighting units 106, 108, 110, 112 have the corresponding design, the lenses and lighting units may be positioned closer to the center axis C of the cluster 104.

According to the illustrated example, the lens 1062 presents mirror symmetry about the single symmetry plane P. As may be seen in FIG. 2b, the lens 1062 is arranged such that the symmetry plane P intersects the lens 1102 of the third lighting unit 110 which is located directly opposite the first lighting unit 106 with respect to center axis C. More specifically, the lenses 1062 and 1102 are arranged such that the symmetry plane P defines a common symmetry plane of the lenses 1062, 1102. As may be appreciated from FIG. 2a, a corresponding design and arrangement apply to the lenses 1082, 1122 of the second and fourth lighting units 108, 112. The mirror symmetry of the individual lenses 1062, 1082, 1102, 1122, and the pair-wise sharing of the symmetry planes between the directly opposite lighting units 106, 110 and 108, 112, lends itself for applications capable of producing a rotationally symmetric collective light beam.

A general example approach for designing a cluster of a lighting device, such as the cluster 104 of the lighting device 100, wherein a collective light beam is formed by a sum of individual light beams output by individual lighting units of the cluster, may comprise:

i. splitting the desired collective beam shape (which e.g. may be symmetric) into a number of individual beams corresponding to the desired number of individual lighting units of the cluster; and
ii. design the lenses of the individual lighting units such that each of the individual lighting units produces an individual beam with the shape determined in step i.

Following this general approach, a lens design may be found which allows the lighting units to be placed closer together than in traditional designs while mitigating a risk of lens cross talk.

As may be appreciated by the skilled person, the specific shapes of the lenses 1062, 1082, 1102, 1122 as shown in FIG. 2a, is merely an example, and many other shapes causing a shift of the mean (and peak) intensity direction of the individual light beam away from the center axis C are possible (e.g. by following the design approach outlined above).

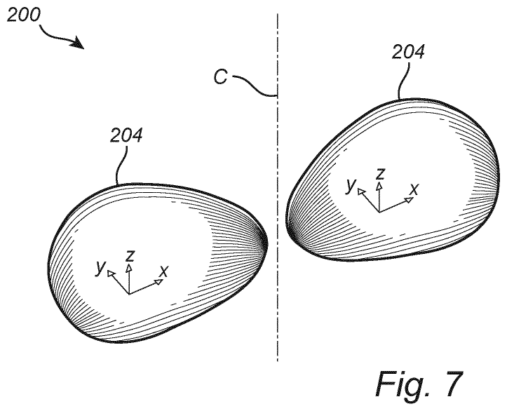

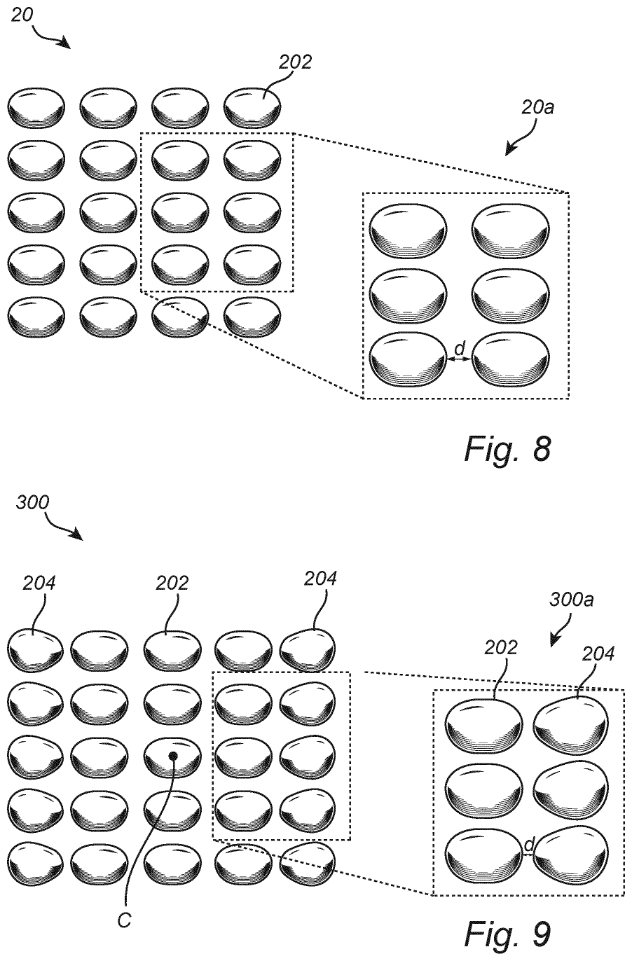

The above examples discussed with reference to FIG. 3a-b and 4a-b, have assumed a uniform output flux of the lighting units 106, 108, 110, 112 and a radially (or quadrant) symmetric collective output beam. In some applications, it may however be desirable to individually adapt the output flux (output intensity) of one or more of the light sources 1061, 1081, 1101, 1121. This allows the shape of the collective beam to be changed from the symmetric shapes mentioned above. This may be useful if, for example, the lighting device 100 is installed close to a wall, wherein the output flux of the lighting units of the cluster 106 closest to the wall may be increased to send more light towards the wall. The output intensity of the light sources 1061, 1081, 1101, 1121 may for instance be predetermined, e.g. set by a one-time commissioning or configuration input. Alternatively, the output flux of the light sources 1061, 1081, 1101, 1121 may be dynamically adjustable during use, e.g. based on a received sensor signal. For instance, the sensor signal may be provided by an object sensor (e.g. detecting or predicting proximity and/or a position of an object such as a user, a user device or a vehicle), wherein the light sources 1061, 1081, 1101, 1121 closest to the object may be controlled to output more light, thus increasing the intensity towards the object. While discussed with reference to the lighting device 100 of FIG. 2a, it is to be noted that these example variations may be applied also to the further embodiments of lighting devices set out herein, such as the lighting devices of FIG. 7 and FIG. 8.

Further cluster and lens designs, capable of producing other beam shapes will now be discussed.

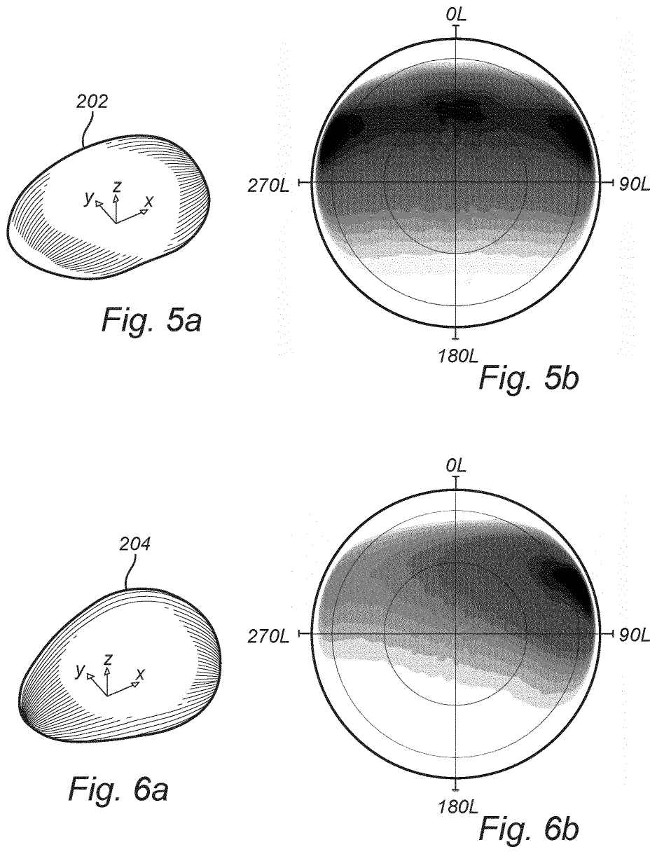

FIG. 5a shows an example of a lens 202 with a design sometimes referred to as a “peanut lens”. The lens 202 has an elongated shape and presents mirror symmetry. The peanut lens 202 comprises a single symmetry plane, extending across the length direction (i.e. along the y-direction) of the lens 202. FIG. 5b shows an example of an intensity distribution of a light beam produced by a lighting unit (e.g. a LED-based light source with a Lambertian emission pattern) comprising the lens 202. As may be seen, the resulting intensity distribution is mirror symmetric and shifted in the 0L direction (upward in the plane of the figure). As an example application, a plurality of individual lighting units comprising a respective lens 202 may be combined in a two-dimensional cluster or array for a down-light road lighting application. The cluster may be mounted such that the symmetry plane of the intensity distribution is oriented transverse to the road direction. By the shifting of the intensity distribution in the 0L direction, the lighting device may be mounted at the road side but still provide the peak intensity closer to the center of the road (or a desired lane of the road as the case may be).

FIG. 6a shows a lens 204, which like the peanut lens 202, has an elongated shape (along the x-direction) but has no symmetry plane. The lens 204 may hence be referred to as an “asymmetric lens”. FIG. 6 shows the intensity distribution produced by a lighting unit comprising the lens 204. As indicated in FIG. 6b, the lens 204 is designed such that together with its mirror image, it produces the same light intensity distribution as the symmetric peanut lens 202 (but with twice the flux, all else equal). Hence, for fair comparison of the intensity distributions in FIGS. 5b and 6b, the design of the lenses 202 and 204 have been calculated such that a pair of symmetric lenses 202 and a pair of mirror-image asymmetric lenses 204 produce the same peak intensities and have the same optical efficiency.

FIG. 7, shows a lighting device 200 comprising a cluster of such a pair of neighboring asymmetric lenses 204, each comprising a first (inner) portion closer to the center axis C, and a second (outer) portion farther from the center axis C, wherein the first portion has a smaller thickness than the second portion. For this particular lens design, the exit surface of the first portion has a smaller curvature (greater radius of curvature) than the exit surface of the second portion. The asymmetric lenses 204 can thus be placed closer than a corresponding pair of symmetric lenses 202, with reduced risk of lens cross talk.

FIG. 8 shows as a comparative example a lighting device 20 comprising a cluster of lighting units with symmetric lenses 202. The separation between neighboring lenses 202, as seen along the length direction of the lenses (left-right in FIG. 8), is d.

FIG. 9 shows a lighting device 300 comprising a cluster of lighting units, each lighting unit comprising a respective symmetric lens 202 (as shown in FIG. 5a) or asymmetric lens 204 (as shown in FIG. 6a). Each lighting unit further comprises, behind each lens 202 or 204, a respective LED-based light source (e.g. corresponding to either of the light sources 1061, 1081, 1111, 1121), which however have been omitted from FIG. 9 for illustrational clarity.

The lighting units comprising the symmetric lenses 202 defines a sub-cluster of lighting units. The lighting units comprising the asymmetric lenses 204 define respectively a first and second set of peripheral lighting units, arranged along opposite peripheral sides of the cluster. In FIG. 8, the first set of peripheral lighting units is defined by the peripheral lighting units arranged along the left hand side of the cluster and the second set of peripheral lighting units is defined by the peripheral lighting units arranged along the right side of the cluster.

As shown, each lens 204 is oriented such that the first (inner) portion thereof (i.e. the portion with the smaller curvature and thickness) is located inwardly with respect to the cluster, i.e. closer to the sub-cluster than the second (outer) portion of the lens 204. Each lens 204 is adapted to shape light collected from the respective light source such that a mean intensity direction of the respective individual light beam output by the lighting unit is directed away from the center axis of the cluster, i.e. towards the respective side of the cluster (to the left for the first set of peripheral lighting units, and to the right for the second set of peripheral lighting units).

Assuming the first and second set of peripheral lighting units provide a uniform output flux, the intensity distribution of the combined output of the first and second of peripheral lighting units is mirror symmetric. Meanwhile, the intensity distribution of the combined output of the sub-cluster is also mirror symmetric (i.e. under the assumption that the lighting units of the sub-cluster provide a uniform output flux). The cluster of the lighting device 300 is hence capable of producing a collective beam with mirror symmetry.

In view of the above discussion with reference to FIG. 7, a spacing d between the asymmetric lens 204 of a lighting unit of the first or second set of peripheral lighting units and a neighboring symmetric lens 202 of the sub-cluster, may be smaller than a spacing between the symmetric lenses 202 within the sub-cluster (c.f. the inset showing cluster portions 20a and 300a of FIG. 8 and FIG. 9, respectively).

The person skilled in the art realizes that the present invention by no means is limited to the preferred embodiments described above. On the contrary, many modifications and variations are possible within the scope of the appended claims. For example, while in the example shown in FIG. 9, the cluster used is arranged in a rectilinear grid, the same design principle can be applied to a staggered grid or a more irregular placement of the lighting units. Moreover, a cluster corresponding to the cluster of FIG. 9 may be designed, wherein the sub-cluster comprises symmetric lenses with quadrant symmetry and the first and second sets of lighting units comprises lenses with mirror symmetry (a single symmetry plane). The two symmetry planes of the symmetric lenses may respectively extend in the left-right direction and the top-down direction of FIG. 9, while the single symmetry plane of the lenses of the peripheral lighting units may extend in the left-right direction of FIG. 9. Such a cluster may provide a collective light beam having an intensity distribution similar to the intensity distribution shown in FIG. 5b, but wherein the band of peak intensities is aligned with the 90L-270L axis (the intensity distribution thus being quadrant symmetric).

1. A lighting device comprising:
a cluster of lighting units, each lighting unit comprising a respective LED-based light source and a respective lens arranged in front of the respective light source and adapted to output a respective individual light beam,
wherein the cluster of lighting units is configured to output a collective light beam formed by a sum of the individual light beams,
wherein the cluster of lighting units comprises a first peripheral lighting unit and a second peripheral lighting unit arranged at opposite peripheral sides of the cluster, and
wherein the respective lens of the first and second peripheral lighting units comprises a first lens portion and a second lens portion, wherein the first lens portion is closer to the center axis of the cluster than the second lens portion, and
wherein the first lens portion has a smaller extension than the second lens portion, therewith adapted to refract a majority of the intensity of the light collected from the respective light source and to shape light collected from the respective light source such that a mean intensity direction of the respective individual light beam is in a direction away from the center axis of the cluster, the cluster of lighting units being configured such that the collective light beam is symmetric with respect to a symmetry plane coinciding with the center axis,
wherein the cluster of lighting units comprises a first set of peripheral lighting units and a second set of peripheral lighting units arranged along the opposite peripheral sides of the cluster.
wherein each peripheral lighting unit of the first and second set comprises a respective lens, wherein each lens is adapted to shape light collected from the respective light source such that a mean intensity direction of the respective individual light beam is directed away from the center axis of the cluster, and
wherein the cluster of lighting units comprises a sub cluster of lighting units, each comprising an LED-based light source arranged in front of a symmetric lens, wherein a spacing between the lens of a peripheral lighting unit and a neighboring symmetric lens of the sub-cluster is less than a spacing between neighboring symmetric lenses of the sub-cluster.

2. The lighting device according to claim 1, wherein the respective lens of each of the first and second peripheral lighting units has a single symmetry plane intersecting the respective lens of another peripheral lighting unit of the cluster.

3. The lighting device according to claim 1, wherein the cluster of lighting units is configured such that, for a uniform flux of the respective LED-based light sources, the collective light beam is symmetric with respect to a symmetry plane coinciding with the center axis, wherein the symmetry is at least one of mirror symmetry, quadrant symmetry or radial symmetry.

4. The lighting device according to claim 1, wherein the cluster of lighting units comprises a third and fourth peripheral lighting unit, wherein the first, second third and fourth lighting units are arranged in a regular grid and located at respective corners of the cluster, and wherein the respective lens of the third and fourth peripheral lighting units is adapted to shape light collected from the respective light source such that a mean intensity direction of the respective individual light beam is directed away from the center axis of the cluster.

5. The lighting device according to claim 4, wherein the first, second, third and fourth peripheral lighting units are neighboring lighting units of the cluster.

6. (canceled)

7. The lighting device according to claim 1, wherein the lenses of the first and second sets of peripheral lighting units are adapted to shape the collected light such that the mean intensity direction of the respective individual light beam is directed away from the opposite peripheral side of the cluster.

8. (canceled)

9. The lighting device according to claim 1, wherein the first and second lighting units are neighboring lighting units of the cluster and arranged on opposite sides of the central axis.

10. The lighting device according to claim 1, wherein each LED-based light source comprises an array of LEDs, wherein the respective lens of each lighting unit is arranged in front of each LED of the array of LEDs.

11. The lighting device according to claim 1, further comprising a cup-shaped reflector surrounding the cluster.

12. The lighting device according to claim 1, wherein the LED-based light sources are configured to, in use of the lighting device, output a substantially uniform flux.

13. The lighting device according to claim 1, wherein at least one of the LED-based light sources is configured to, in use of the lighting device, output a flux different from the other LED-based light sources.
